(19) United States
(12) Patent Application Publication
(10) Pub. No.: US 2023/0038146 A1
(43) Pub. Date: Feb. 9, 2023

(54) CART POS CONTROL BOARD, BATTERY CHECK SYSTEM, AND PROGRAM

(71) Applicant: TOSHIBA TEC KABUSHIKI KAISHA, Tokyo (JP)

(72) Inventor: Yasuhiro Katabira, Tagata Shizuoka (JP)

(21) Appl. No.: 17/739,273

(22) Filed: May 9, 2022

(30) Foreign Application Priority Data
Aug. 6, 2021 (JP) 2021-130319

(51) Int. Cl. B62B 5/00; B62B 3/14; A47F 10/02

(52) U.S. Cl. CPC B62B 5/0096; B62B 3/1424; B62B 3/1412; A47F 10/02

(57) ABSTRACT

A cart POS control board according to an embodiment includes a storing unit and a control unit. The storing unit stores, in association with each other, identification information of a battery that may receive power supply and setting concerning control for the battery. If identification information of the battery acquired by an acquiring unit is stored in the storing unit, the control unit controls the battery according to setting associated with the identification information.

### CROSS-REFERENCE TO RELATED APPLICATION

This application is based upon and claims the benefit of priority from Japanese Patent Application No. 2021-130319, filed on Aug. 6, 2021, the entire contents of which are incorporated herein by reference.

### FIELD

Embodiments described herein relate generally to a cart POS control board, a battery check system, and a program.

### BACKGROUND

In recent years, in a supermarket or a volume retailer, there has been a cart attached with an information terminal such as a tablet terminal and a reader such as a scanner as a cart on which commodities sold in the store or a basket in which the commodities are put is placed. A customer reads, with the reader, a symbol such as a barcode attached to a purchase desired commodity and puts the commodity in the basket placed on the cart. Information such as a commodity name and a price of the commodity, the symbol of which is read, is displayed on the information terminal.

The information terminal is sometimes attached to a battery. In such a case, the customer checks whether the connected battery is usable. As a method of performing the check, besides authentication by mutual connection by an IC chip, there is a method of performing the check using a server through a network.

However, in such an authentication method, means used to perform communication with the battery or the server is necessary. Therefore, in a situation in which a battery or a cart POS not including an IC chip cannot be connected to the network, it cannot be checked whether the battery is usable.

### DESCRIPTION OF THE DRAWINGS

FIG. 1 is a perspective view illustrating a cart POS according to an embodiment;

FIG. 2 is a diagram illustrating a battery check system including the cart POS;

FIG. 3 is a block diagram illustrating an example of a hardware configuration of a control board according to the embodiment;

FIG. 4 is a diagram illustrating an example of a data configuration of model number management information stored in a storing unit of the control board;

FIG. 5 is a flowchart for explaining a flow of model number check processing for a battery by a control unit of the control board;

FIG. 6 is an example of a notification displayed by a display unit of an information terminal if, as a result of a check, an unusable battery is connected; and

FIG. 7 is a block diagram illustrating a modification of the hardware configuration of the control board.

### DETAILED DESCRIPTION

An aspect of embodiments is to, in order to solve the problems described above, provide a cart POS control board, a battery check system, and a program that can check, by connecting a battery to a port of a cart POS, whether the battery is usable.

A cart POS control board according to an embodiment includes a storing unit and a control unit. The storing unit stores, in association with each other, identification information of a battery that may receive power supply and setting concerning control for the battery. If identification information of the battery acquired by an acquiring unit is stored in the storing unit, the control unit controls the battery according to setting associated with the identification information.

An embodiment is explained with reference to the drawings.

In the embodiment, a battery is connected to a port of a cart POS (Point of Sales) to check whether the battery is usable.

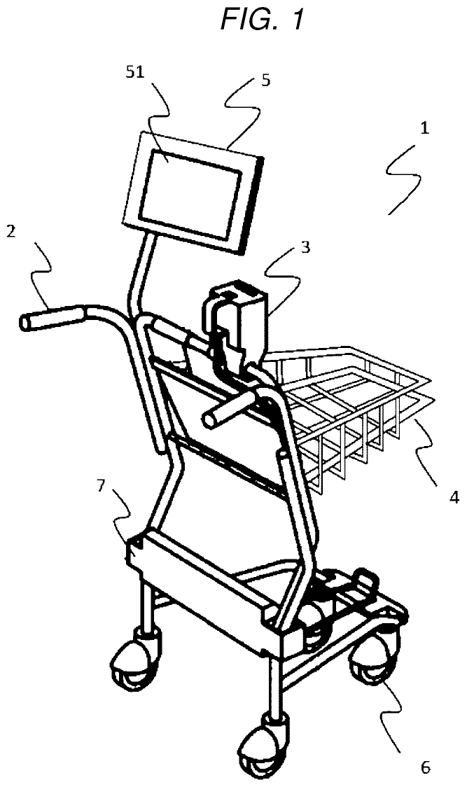

FIG. 1 is a perspective view illustrating the cart POS according to the embodiment.

A cart POS 1 is a cart that stores commodities to be purchased while moving in a store. A customer pushes and moves the cart POS 1. The cart POS 1 includes a handle 2, a scanner 3, a basket placing section 4, a terminal 5, casters 6, and a battery case 7. In the cart POS 1, electric power is supplied to the scanner 3 and the terminal 5 from a battery 9 explained below. In the cart POS 1, devices that receive supply of electric power from the battery 9 are power-supplied units.

The handle 2 is a part that an operator grips to move the cart POS 1. The scanner 3 recognizes, optically or by imaging, a code symbol such as a barcode or a two-dimensional code attached to a commodity. The scanner 3 decodes the recognized code symbol and reads a commodity code indicated by the code symbol. The scanner 3 transmits the read commodity code to the terminal 5. At this time, the scanner 3 transmits the commodity code to the terminal 5 by radio or wire. If transmitting the commodity code by wire, the scanner 3 may transmit the commodity code via a control board 8. The basket placing section 4 is a stand on which a shopping basket storing commodities is placed. The terminal 5 is, for example, a tablet terminal. The terminal 5 executes registration processing for receiving the commodity code read by the scanner 3, acquiring commodity information such as a commodity name and price information corresponding to the commodity code, and storing the commodity information in the terminal 5. The terminal 5 can be connected to a network by a communication line such as a wireless LAN (Local Area Network) or short-rang wireless communication. The terminal 5 includes a display unit 51. The terminal 5 is a display device such as a liquid crystal display or an organic EL (Electro Luminescence) display. The display unit 51 displays, for example, a notification performed if a deficiency or the like occurs besides commodity information, information relating to checkout processing such as a transaction amount and a change amount, and the like registered by an operator who operates the terminal 5. The display unit 51 is configured as a touch panel. The operator directly touches the display unit 51 to input an instruction to the terminal 5.

Four casters 6 are provided in the bottom of the cart POS 1. The respective casters 6 individually rotate, whereby the cart POS 1 can freely move in the store by being pushed by the customer.

The battery case 7 houses the control board 8 and the battery 9 explained below. In this embodiment, the battery case 7 is located above the casters 6. However, the battery case 7 may be connected below the basket placing section 4.

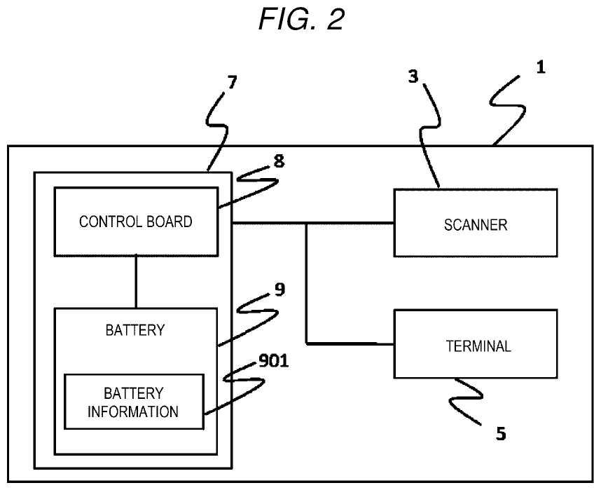

FIG. 2 is a diagram illustrating a battery check system including the cart POS 1 according to the embodiment.

The control board 8 controls the battery 9 connected thereto. The control board 8 includes a connecting unit for connecting the control board 8 to the scanner 3, the terminal 5, and the battery 9. As an example of the connecting unit, the control board 8 includes a USB (Universal Serial Bus) port. As an example, a standard of a USB terminal is a USB Type-C. The control board 8 is connected to the battery 9 and supplies electric power to the scanner 3 and the terminal 5. At this time, a terminal that connects the control board 8 and the battery 9 is a USB terminal. A standard of the terminal is the USB Type-C. Therefore, a USB connector that connects the control board 8 and the battery 9 is capable of not only supplying electric power but also performing transmission and reception of information by performing communication. Besides controlling the supply of electric power, the control board 8 can also perform control for stopping the supply. Besides the control for the supply of electric power and the stop of the supply, the control board 8 acquires information concerning the battery 9 from the connected battery 9 and checks whether the battery 9 is a usable battery. If the acquired information concerning the battery 9 is not stored in the control board 8, the control board 8 stops the power supply from the battery 9.

The cart POS 1 includes the scanner 3, the terminal 5, the control board 8, and the battery 9. The scanner 3, the terminal 5, the control board 8, and the battery 9 include USB port for connecting those to the control board 8, which is external equipment. The control board 8 is connected to the scanner 3, the terminal 5, and the battery 9 and supplies, to the scanner 3 and the terminal 5, electric power supplied from the battery 9. The battery 9 supplies electric power to the scanner 3 and the terminal 5 via the control board 8.

The battery 9 includes a not-illustrated microcomputer. Battery identification information 901 is stored in a not-illustrated storing unit configured by a ROM (Read Only Memory) and a RAM (Random Access Memory) in the microcomputer. The battery identification information 901 means an identifier for identifying an individual battery. Examples of the identifier include a model number of the battery. In FIG. 2, only one battery 9 connected to the control board 8 is illustrated. However, two or more batteries 9 may be connected to the control board 8.

Information indicating that the battery 9 capable of supplying electric power to the terminal 5 and the like in this embodiment can be used in the control board 8 is stored. That is, in this embodiment, for the battery 9 capable of supplying electric power to the terminal 5 and the like via the control board 8, the same battery identification information 901 as the battery identification information 901 such as a model number of the battery 9 has to be stored in the control board 8. Therefore, if battery information of a battery connected to the control board 8 is not stored in the control board 8, power supply from the battery is stopped.

Stability of the operation of the battery 9 is different depending on a model number. There are, for example, a battery that can unconditionally perform power supply, a battery that requires restart at every fixed time, and a battery that unstably operates at a normal voltage set if power supply is performed in the standard of the USB Type-C. A time required for a response of the battery 9 is different depending on a model number.

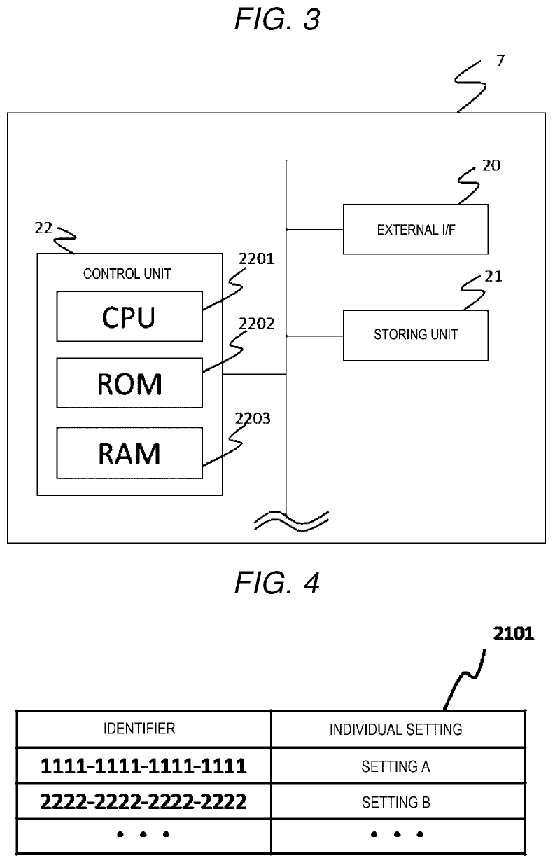

FIG. 3 is a block diagram illustrating an example of a hardware configuration of the control board 8. The control board 8 includes an external I/F 20, a storing unit 21, and a control unit 22. The external I/F 20 is a USB port for connecting the control board 8 and external equipment. The external I/F 20 performs transmission and reception of information and signals between the control board 8 and the scanner 3, the terminal 5, and the battery 9. Besides transmission and reception of signals for confirming that the control board 8 and the scanner 3 are connected to each other, the control board 8 is capable of receiving information read by the scanner 3 such as a commodity code and transmitting the information to the terminal 5. Besides transmission and reception of signals for confirming that the control board 8 and the terminal 5 are connected to each other, the control board 8 performs notification according to a result of confirmation processing performed between the control board 8 and the battery 9. Besides transmission and reception of signals for confirming that the control board 8 and the battery 9 are connected to each other, the control board 8 acquires, from the battery 9, the battery identification information 901 and information concerning the battery 9 such as a voltage used during power supply. The control board 8 also performs supply of electric power with the external I/F 20.

The storing unit 21 is configured by a storage medium such as a HDD (Hard Disc Drive) or a flash memory. The storing unit 21 stores an operating system, other software such as application programs, and the like necessary for the control board 8 to operate.

FIG. 4 is a diagram illustrating an example of a data configuration of model number management information 2101 stored in the storing unit 21 of the control board 8. The model number management information 2101 includes an identifier and individual setting. The identifier means a model number of a battery capable of supplying electric power to the terminal 5 and the like. The individual setting means setting of battery control performed for each of batteries. The individual setting is stored to correspond to the model number management information 2101. Examples of the setting of the battery control include setting for unconditionally performing power supply, setting for performing restart at every fixed time (for example, ten minutes), and setting for changing a voltage during power supply from 20 V of normal setting to 15 V and performing power supply. In this embodiment, the three settings are described above. However, the three settings are presented as examples and are not intended to be limited thereto. The setting for unconditionally performing power supply is default setting of the setting of the battery control in this embodiment.

Referring back to FIG. 3, the control unit 22 includes a CPU (Central Processing Unit) 2201, a ROM (Read Only Memory) 2202, and a RAM (Random Access Memory) 2203. The CPU 2201 controls the entire control board 8. The ROM 2202 stores various programs such as a program used to drive the CPU 2201 and various data. The RAM 2203 is used as a work area of the CPU 2201. Programs of various kinds of software and various data stored in the ROM 2202 and the storing unit 21 are loaded in the RAM 2203. The CPU 2201 operates according to an information processing program stored in the ROM 2202 or the storing unit 21 and loaded in the RAM 2203, whereby the control unit 22 executes various kinds of functional processing of the control board 8. The control unit 22 acquires the received battery identification information 901. The control unit 22 checks whether the same model number as the model number in the battery identification information 901 acquired via software stored in the storing unit 21 is stored in the storing unit 21. The control unit 22 performs rewriting processing for the model number management information 2101 stored in the storing unit 21 and performs processing for notifying a check result to the terminal 5.

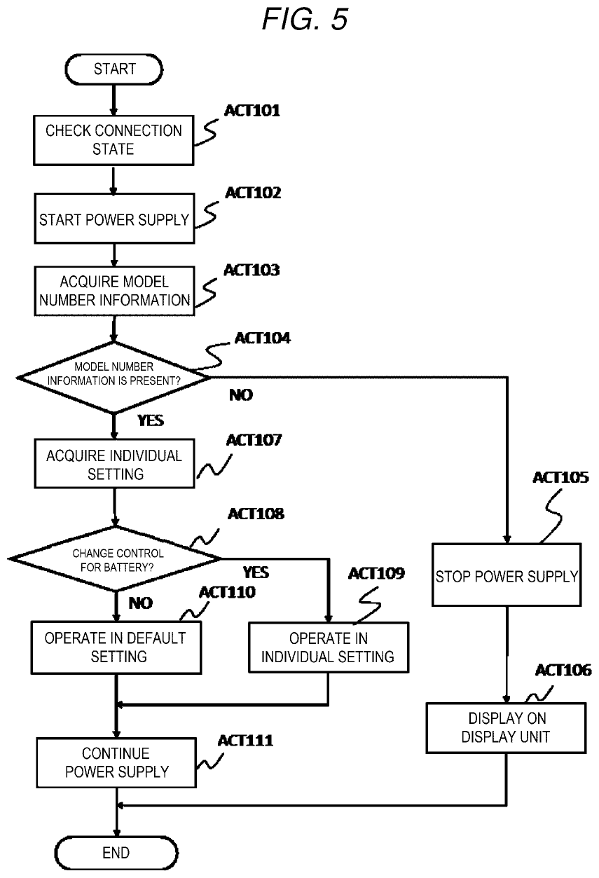

FIG. 5 is a flowchart for explaining a flow of model number check processing for the battery 9 by the control unit 22 of the control board 8.

The control unit 22 checks a connection state to the battery 9 (ACT 101). The control unit 22 transmits, to the connected battery 9, via the external I/F 20, a signal for checking whether the battery 9 is normally connected. The control unit 22 receives, from the battery 9, via the external I/F 20, a signal indicating that the battery 9 is normally connected. The control unit 22 starts power supply from the battery 9 (ACT 102). The control unit 22 temporarily performs power supply from the battery 9 while performing processing for checking a model number of the battery 9. Power supply from the battery 9 in this processing is performed to the terminal 5 as well. The control unit 22 acquires the battery identification information 901 from the battery 9 (ACT 103). The control unit 22 requests the connected battery 9 to transmit the battery identification information 901 and acquires the battery identification information 901 by receiving the battery identification information 901 from the battery 9.

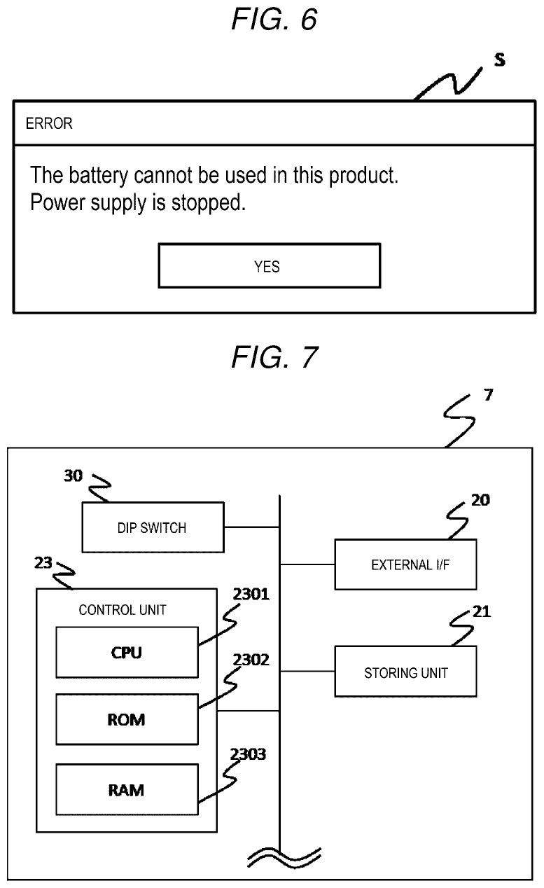

The control unit 22 checks whether the acquired battery identification information 901 is present in the storing unit 21 (ACT 104). The control unit 22 checks, based on the acquired battery identification information 901, whether battery information having the same information is present in the model number management information 2101. That is, the control unit 22 checks whether the same battery identification information 901 as the acquired battery identification information 901 is stored as model number information in the model number management information 2101. If the same information as the acquired battery identification information 901 is absent in the model number management information 2101 (NO in ACT 104), the control unit 22 stops the power supply to the terminal 5 (ACT 105). Since the control unit 22 successfully confirms that the battery 9 connected to the control board 8 is not a battery that may supply electric power to the terminal 5, the control unit 22 stops the supply of electric power to prevent the terminal 5 from causing a deficiency. The control unit 22 transmits a notification of a check result to the terminal 5 (ACT 106). The terminal 5, to which the notification is transmitted, displays, for example, a notification example S illustrated in FIG. 6 on the display unit 51.

If the same information as the acquired battery identification information 901 is present in the model number management information 2101 (YES in ACT 104), the control unit 22 acquires individual setting (ACT 107). The control unit 22 acquires individual setting associated with model number information in the model number management information 2101 that is the same as the acquired battery identification information 901.

The control unit 22 checks whether it is necessary to change control setting for the connected battery 9 (ACT 108). If it is necessary to change control for the battery 9 from the acquired individual setting (YES in ACT 108), the control unit 22 causes the battery 9 to operate in the individual setting (ACT 109). For example, if the battery 9 is set to “be restarted in every ten minutes” in the individual setting associated with the model number information, the control unit 22 performs control to restart the battery 9 in every ten minutes.

If confirming that it is unnecessary to change the control for the battery 9 from the acquired individual setting (NO in ACT 108), the control unit 22 causes the battery 9 to operate in the default setting (ACT 110). The default setting in this embodiment indicates setting for unconditionally performing power supply. That is, the control unit 22 controls the battery 9 to supply electric power without performing control for, for example, restarting the battery 9. If completing processing for enabling normal power supply from the battery 9, the control unit 22 maintains a power supply state and ends the model number check processing for the battery 9 (ACT 111).

### Modifications of the Embodiment

The control board 8 may include a DIP switch 30.

FIG. 7 is a block diagram illustrating a modification of the hardware configuration of the control board 8. The DIP switch 30 switches setting of control for the battery 9 performed by the control board 8. The DIP switch 30 includes a plurality of switches. The DIP switch 30 switches the switches to thereby change control for the battery 9 performed at a battery connection time. Settings for performing different controls on the battery 9 and the respective switches correspond to each other.

Specifically, for example, the DIP switch 30 is implemented with a switch for performing control for unconditionally performing power supply (hereinafter, switch A), a switch for performing control for performing restart every time ten minutes elapse from a power supply start (hereinafter, switch B), and a switch for performing control for increasing a time from connection until reception of a reply from ten seconds to fifteen seconds (hereafter, switch C). Among these switches, the switch A is set to ON as default setting. In such a case, if the operator switches the switch A to the switch B, the control board 8 is fixed to perform control for restarting the battery 9 every time 10 minutes elapses from the power supply start. Therefore, even if the control can be performed in the default setting as a result of the check processing for the connected battery 9, the control board 8 performs control for performing the restart every time ten minutes elapses from the power supply start.

The DIP switch 30 may include a switch for switching the control board 8 to a state in which the control board 8 can perform rewriting of the model number management information 2101. By turning on the switch for switching the control board 8 to the state in which the control board 8 can perform the rewriting of the model number management information 2101, the control board 8 changes to a state in which the control board 8 can edit the model number management information 2101 stored in the storing unit 21. At this time, the rewriting of the model number management information 2101 may be performed by the terminal 5 connected to the control board 8 or may be directly acquired from the connected battery 9.

In this embodiment, the connection of the control board 8 and the battery 9 is explained above with the USB Type-C as an example. However, the connection is not limited to the USB type-C. If the control board 8 and the battery 9 are connected, an identifier such as a model number of the battery 9 only has to be able to be transmitted simultaneously with the power supply to the control board 8.

In this embodiment, the power-supplied units are the scanner 3 and the terminal 5. However, the power-supplied unit may be only the scanner 3 or may be only the terminal 5. A device that does not receive power supply from the battery 9 may separately incorporate a battery.

In this embodiment, if the model number check processing for the battery 9 by the control unit 22 of the control board 8 is performed, as an example, the power supply is temporarily performed from the battery 9. However, not only this, but, for example, the control unit 22 of the control board 8 performs control to supply electric power from another battery (for example, a battery included in the terminal 5) without supplying electric power from the battery 9.

In the embodiment, a function of implementing the embodiment is recorded in advance in a device. However, not only this, but the same function may be downloaded to the device from a network or the same function stored in a recording medium may be installed in the device. A form of the recording medium may be any form if the recording medium is a recording medium that can store a program and can be read by the device such as an optical disk. The function obtained by the installation or the download in advance may be realized in cooperation with an OS (operating system) or the like in the device.

The several embodiments are explained above. However, these embodiments are presented as examples and are not intended to limit the scope of the invention. These new embodiments can be implemented in other various forms. Various omissions, substitutions, and changes can be made without departing from the spirit of the invention. These embodiments and modifications of the embodiments are included in the scope and the gist of the invention and included in the inventions described in claims and the scope of equivalents of the inventions.

What is claimed is:

1. A cart POS control board, comprising:
a storage component configured to store, in association with each other, identification information of a battery configured to receive power supply and setting concerning control for the battery; and
a controller configured to acquire the identification information of the battery from the battery connected to the controller and, if the identification information of the battery is stored in the storage component, control the battery according to setting associated with the identification information.

2. The cart POS control board according to claim 1, wherein, if the acquired identification information of the battery is not stored in the storage component, the controller performs control not to transmit electric power of the battery to a power-supplied component.

3. The cart POS control board according to claim 1, further comprising a DIP switch including a plurality of switches for fixing the control performed on the battery by the controller to individually set control.

4. The cart POS control board according to claim 1, wherein the cart POS control board is connected to the battery and supplies electric power to a scanner and a terminal.

5. A cart POS, comprising:
a handle;
a scanner;
a basket placing section;
a terminal;
a plurality of casters; and
a battery case comprising the cart POS control board according to claim 1 and a battery.

6. The cart POS according to claim 5, wherein cart POS control board 8 includes a connecting component for connecting the control board to the scanner, the terminal, and the battery.

7. The cart POS according to claim 5, wherein the cart POS control board is connected to the battery and supplies electric power to the scanner and the terminal.

8. A battery check system, comprising:
a battery identification-information acquiring component for acquiring identification information of a battery for specifying the battery;
a storage component for storing, in association with each other, identification information of the battery configured to receive power supply and setting concerning control for the battery;
a determining component for determining whether the identification information of the battery acquired by the acquiring component and battery information are stored; and
a controller for, if the identification information of the battery is stored, performing battery control corresponding to the setting associated with the identification information.

9. The battery check system according to claim 8, wherein the controller checks whether a same battery identification information as the acquired battery identification information is stored as model number information in a model number management information.

10. The battery check system according to claim 9, wherein when the same information as the acquired battery identification information is absent in the model number management information, the controller stops the power supply to a terminal.

11. The battery check system according to claim 8, wherein when the controller successfully confirms that the battery connected to a cart POS control board is not a battery that supplies electric power to a terminal, the controller stops supply of electric power to prevent the terminal from causing a deficiency.

12. The battery check system according to claim 8, wherein the controller transmits a notification of a check result to a terminal.

13. The battery check system according to claim 12, wherein the terminal to which the notification is transmitted, displays, a notification example on a display.

14. A battery check method, comprising:
supplying electric power from a battery;
acquiring identification information of the battery for specifying the battery;
storing, in association with each other, identification information of the battery configured to receive power supply and setting concerning control for the battery; and
if the identification information of the battery is stored, performing battery control corresponding to the setting associated with the identification information.

15. The battery check method according to claim 14, further comprising:
checking whether a same battery identification information as the acquired battery identification information is stored as model number information in a model number management information.

16. The battery check method according to claim 15, further comprising:
when the same information as the acquired battery identification information is absent in the model number management information, stopping the power supply to a terminal.

17. The battery check method according to claim 14, further comprising:
when confirmation that the battery connected to a cart POS control board is not a battery that supplies electric power to a terminal, stopping supply of electric power to prevent the terminal from causing a deficiency.

18. The battery check method according to claim 14, further comprising:
transmitting a notification of a check result to a terminal.

19. The battery check method according to claim 18, further comprising:
displaying, a notification example on a display of the terminal.
